(19) United States
(12) Patent Application Publication
(10) Pub. No.: US 2014/0209330 A1
(43) Pub. Date: Jul. 31, 2014

(54) AUTOMATED WILDFIRE PREVENTION AND PROTECTION SYSTEM FOR DWELLINGS, BUILDINGS, STRUCTURES AND PROPERTY

(71) Applicant: HAS LLC, Jackson, WY (US)

(72) Inventors: Harry Statter, Jackson, WY (US); Tom Barrett, Noblesville, IN (US); Stephen C. Haeske, Allendale, MI (US)

(73) Assignee: HAS LLC, Jackson, WY (US)

(21) Appl. No.: 14/080,326

(22) Filed: Nov. 14, 2013

Related U.S. Application Data
(60) Provisional application No. 61/726,066, filed on Nov. 14, 2012.

(51) Int. Cl. A62C 3/02

(52) U.S. Cl. CPC A62C 3/0214
USPC 169/46; 169/54; 169/70; 169/61

(57) ABSTRACT

A fire retardant delivery system for protection from wildfire is provided. The system includes a retardant tank for storing a fire retardant and a carrier tank for storing a carrier for the fire retardant. Alternatively, the system includes a fire retardant tank fluidly coupled with a carrier provided from a suitable source. The retardant tank and the carrier joined in a tank arrangement. A supply of a motive source is in fluid communication with the tank arrangement. An activation system disperses the supply of the motive source into the tank arrangement so that the fire retardant and the carrier are mixed into a fire retardant and carrier mixture after actuation of the activation system. At least one distribution nozzle delivers the fire retardant and carrier mixture to a desired area.

### CROSS-REFERENCE TO RELATED APPLICATIONS

The present patent application claims priority to and is a non-provisional U.S. patent application of U.S. Provisional Patent Application Ser. No. 61/726,066 filed on Nov. 14, 2012 and having the title “AUTOMATED WILDFIRE PREVENTION AND PROTECTION SYSTEM FOR DWELLINGS, BUILDINGS, STRUCTURES AND PROPERTY”, which is herein incorporated by reference in its entirety.

### TECHNICAL FIELD OF THE DISCLOSURE

The present disclosure generally relates to the apparatus, techniques, and methods designed to protect structures from wildfire and to control wildfire behavior and direction. More specifically, the present disclosure relates to a fire prevention and protection system for mixing, transferring, and distributing a fire retardant in and to desired areas around and on the exterior surfaces of structures when needed, or in specific areas to impede or redirect the progression of the wildfire.

### BACKGROUND OF THE DISCLOSURE

Wildfires across the United States are increasing in frequency and magnitude. Many authorities are calling 2012 the worst year for wildfires in the history of America. In Colorado alone there have been 13 major wildfires, burning 225,000 acres and destroying 600 homes. In 2012, Colorado experienced unusually high temperatures and extremely dry conditions.

Although the relationship between climate change and the incidence of wildfires is speculative, the number of dwellings, buildings, structures, and property at risk is increasing. In the past decade, almost 40% of US homes have been built in the “wildland-urban interface,” or areas where residential neighborhoods border upon forests or grasslands.

This is particularly true in the Central and Western regions of the United States, where wildfires have destroyed thousands of homes and other structures. About $3 billion is spent annually to fight these fires and this figure does not measure the entire economic impact of such fires.

Correspondingly, and as drought conditions continue to spread, the destruction risk from wildfire to residences exists throughout the U.S. and all other forested areas or grasslands in all other parts of the world. Accordingly, this is a global risk without precedent.

As more homes and communities are built along the interface between urban and forested areas, and particularly in areas that are historically burned by wildfires, correspondingly more and more of these structures are directly exposed to the risks of destruction by wildfires. This population and construction trend, coupled with historical timber management practices that have led to increased forest fuel loading in recent decades, and rapidly increasing drought conditions existing across the Central and Western U.S., have led to an unprecedented number of structures being in danger of exposure to, and destruction by, wildfires.

Under certain conditions, conventional methods of fighting wildfires may have little impact when the fires enter the urban-wildland interface where residential subdivisions have been built. Wildfire fighters often can only stand back and watch as homes in the path of a wildfire are destroyed. The inability of wildfire fighters to prevent wildfire from destroying communities has been seen dramatically in the past several years, during which many highly publicized wildfires destroyed thousands of homes throughout the Central and Western U.S., including Arizona, California, Idaho, Nevada, Texas, Oklahoma, Utah and other states.

The costs associated with fighting wildfires pale in comparison to the costs of lost homes and other structures destroyed by wildfires. For example, according to the Insurance Services Office, Inc., the estimated insured losses arising out of the wildfires in San Diego and San Bernadino counties in Southern California in 2003 alone exceeded over $2 billion. Of this, over $1 billion in payments arose out of a single wildfire—the Cedar Fire—which destroyed over 2,200 residential and commercial buildings. On a nationwide basis, the annual insured losses attributable to wildfires for 2012 will be undoubtedly much higher and are known to have exceeded $5 billion by mid-year. The global losses are likely a strong multiple of this mid-year figure and may well exceed $100 billion when finally tallied—which may take some years.

Given the staggering amounts of economic and environmental damage caused by wildfires, there is increasing interest in mitigation techniques that reduce the risks to both communities and forested lands.

With respect to homes and business structures, there are several wildfire mitigation strategies that can be taken to alleviate the risk of wildfires destroying dwellings, residences, and buildings. These include relatively simple measures such as using non-combustible materials during construction and establishing an effective “defensible space” or vegetation clearing around homes located in at-risk areas.

Many communities have adopted on a community-wide basis programs to decrease fuel loads around urban-wildland interfaces by aggressively thinning brush and carefully managing controlled “burns.” Good community planning before residential areas are built is important. It may be unwise to locate residential developments in areas that are highly prone to wildfires and are not conducive to defensible space clearing, brush clearing or controlled burns.

Nonetheless, homes, commercial structures and other buildings continue to be built at the edges of the urban areas where the risk of wildfire is the greatest, and even deep in forested areas, much of the time for aesthetic reasons. Accordingly, there is an immediate need for systems that eliminate, reduce or at least substantially mitigate the risk that wildfires will destroy structures such as homes and the like, wherever they are built. The presently disclosed embodiments are directed toward meeting this need.

### SUMMARY OF THE DISCLOSED EMBODIMENTS

An automatic wildfire prevention and protection system is disclosed that is designed to prevent structures and the immediate surrounding property areas from catching fire when a wildfire approaches and threatens the aforementioned structures and property. This fire prevention and protection system is designed for use on and with any type of structure such as residences, dwellings, out buildings, barns, commercial buildings, other such structures, and landscapes.

The system relies upon a distribution system that, when activated, very rapidly coats the exterior of the structures, decks and surrounding landscape with a fire retardant compound that remains on the surface and remains effective in suppressing combustion until deliberately washed off. The system is self-contained and substantially autonomous in operation.

The system relies upon tanks pressurized with inert gas, compressed gas, electric, gravity, or another motive source to mix the fire retardant compound with a carrier and transfer the mixed fire retardant compound to spray valves that are installed and positioned on and around the structures and surrounding areas.

An alternate embodiment of this system uses compressed gas-powered pumps, electric, gravity or another motive source to mix, transfer and deliver the fire retardant to desired areas to control the direction and behavior of the threatening wildfire.

In one embodiment, a fire retardant delivery system for protection from wildfire is provided. The system includes a retardant tank for storing a fire retardant and a carrier tank for storing a carrier for the fire retardant. The retardant tank and the carrier tank joined in a tank arrangement. A motive source is in fluid communication with the tank arrangement. An activation system activates the motive source into the tank arrangement so that the fire retardant and the carrier are mixed into a fire retardant and carrier mixture after actuation of the activation system. At least one distribution nozzle delivers the fire retardant and carrier mixture to a desired area.

In one embodiment, a method of delivering fire retardant over a desired area is provided. The method includes storing a fire retardant in a retardant tank and storing a carrier for the fire retardant in a carrier tank. The retardant tank and the carrier tank are joined in a tank arrangement. A motive source is fluidly coupled with the tank arrangement. The motive source is dispersed into the tank arrangement so that the fire retardant and the carrier are mixed into a fire retardant and carrier mixture after actuation of an activation system. The fire retardant and carrier mixture is delivered to the desired area through at least one distribution nozzle.

In one embodiment, the system relies on a carrier from a source other than a tank. For purposes of a non-limiting example, a water well, municipal water supply, pond, water tank, water well, lake, or any other such water supply source provides a carrier to be fluidly coupled with fire retardant from a tank. The fire retardant and carrier mixture is delivered to the desired area through at least one distribution nozzle using any available motive source of power.

### BRIEF DESCRIPTION OF THE DRAWINGS

The embodiments described herein will be better understood and its numerous objects and advantages will be apparent by reference to the following detailed description of the embodiments when taken in conjunction with the following drawings.

FIG. 1 is a schematic top plan view of a residential structure and the area surrounding the structure, illustrating one embodiment of the fire retardant distribution system according to the present embodiments.

FIG. 2 is a schematic layout view of the fire retardant distribution system shown in FIG. 1 with the structure removed to illustrate the system.

FIG. 3 is a schematic view of the primary systems according to one embodiment, including the distribution system, the storage system and the control system.

FIG. 4 is a schematic view of the control system according to one embodiment.

FIG. 5 is a schematic top plan view of a perimeter fire retardant distribution system according to a second embodiment.

FIG. 6 is a schematic view of another primary system according to one embodiment, including the distribution system, the storage system and the control system.

### DETAILED DESCRIPTION OF THE DISCLOSED EMBODIMENTS

In some embodiments, a fire retardant distribution system is disclosed for use on any type of structure including residences, out buildings, barns, commercial buildings, and others, to name just a few non-limiting examples. The system is designed to prevent structures from catching fire when a wildfire approaches, and relies upon a spray system that when activated quenches and coats the exterior of the structures, decks and surrounding landscape very rapidly with a fire retardant that remains on the surface until washed off. The system is self-contained and relies upon tanks pressurized by a motive source such as inert gas, combustible fuel, electric, gravity, pump, or another power source to deliver the fire retardant to spray valves positioned on and around the structures. The motive source is operatively coupled to the retardant tank and the source of carrier.

There may be no need for electrical power in some embodiments, although electrical power may be supplied by a battery backup system, uninterruptible power supply, or other source of local electrical energy if an electrically operated control system is used. The system may be activated manually, or may optionally include a control module that allows the system to be activated in any number of ways, including inputs by manual activation, remote telemetry and by remote access (such as by DTMF telephone, mobile device application, or internet link, to name just a few non-limiting examples).

Other embodiments are directed toward blocking or re-directing the progress of a wildfire, and comprise a pump powered by combustible compressed fuel, electric, or other power source that is connected to a reservoir of non-pressurized retardant and a series of distribution devices connected to the outflow of the pump. The distribution devices are positioned to spray the fire retardant in a line or arc that either blocks progress of a wildfire, or channels or blocks the direction of the fire in a desired manner. Several subsystems, each comprising a pump and the associated distribution devices may be laid out in series so that a fire retardant protection line several miles long may be quickly laid down on vegetation. This “flanking” technique allows wildfire fighters to control fire direction and behavior at critical points, typically near communities.

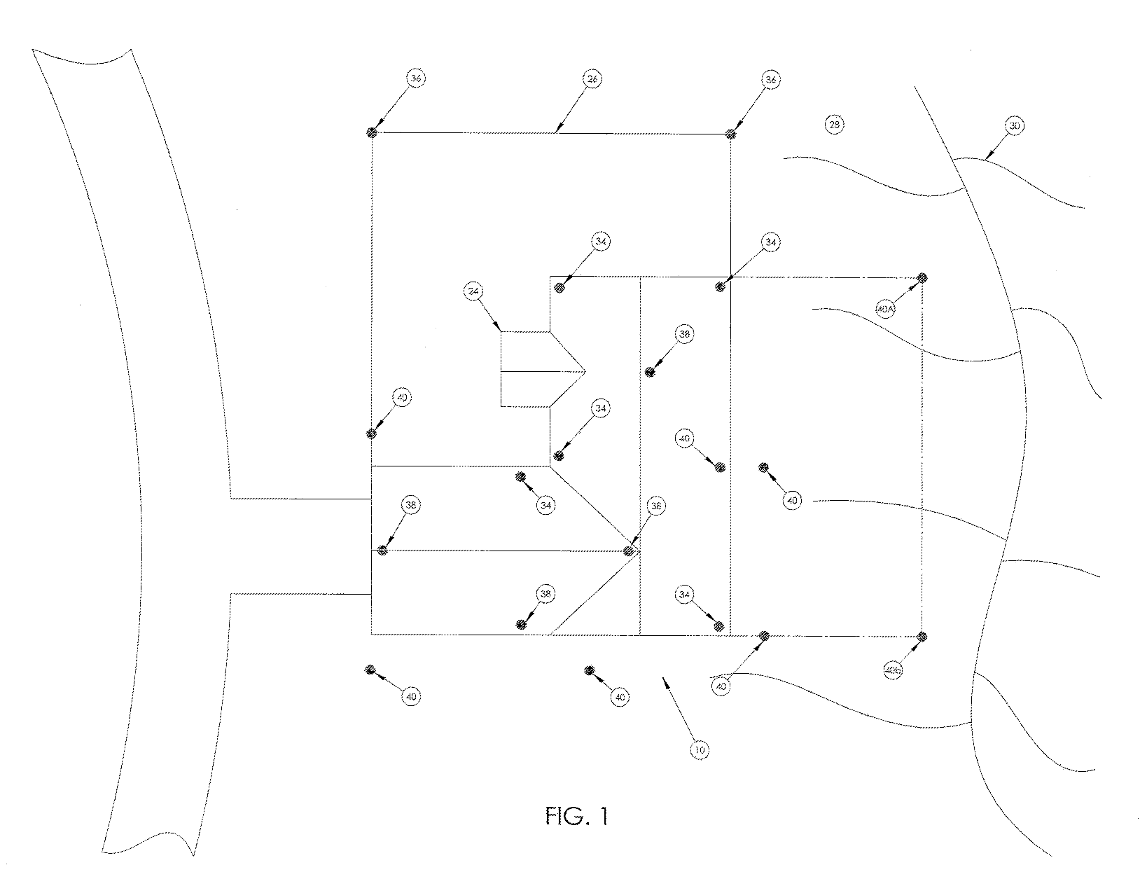

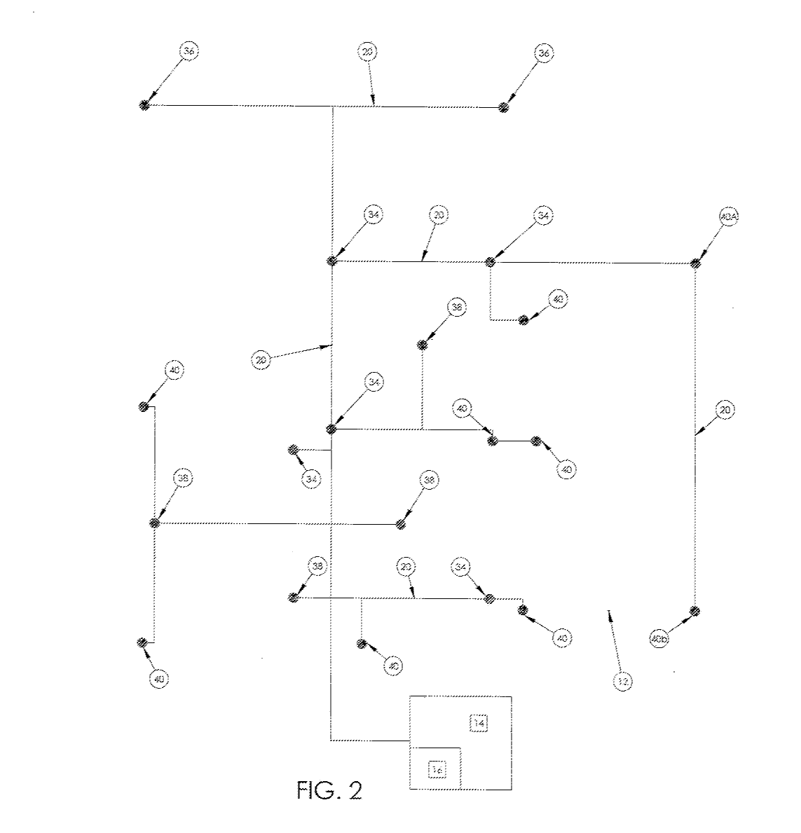

With reference to FIGS. 1 and 2, a fire retardant distribution system 10 is illustrated schematically in a typical installment in a residential setting that includes a building 24 such as a typical home located near an urban-wildfire interface area. The system illustrated in FIGS. 1 and 2 is only an illustrative example, and those skilled in the art will recognize from the present disclosure that many other configurations are possible and will be configured depending upon the desired area to be protected. In one embodiment, the desired area is defined as an area between a structure and at least one historical fire originating location. In one embodiment, the desired area is defined based upon temperature inputs from real-time remote telemetry. In one embodiment, the desired area is defined based upon relative humidity inputs from real-time remote telemetry. In one embodiment, the desired area is defined based upon wind patterns inputs from real-time remote telemetry. In one embodiment, the desired area is defined based upon historical fire data. In one embodiment, the desired area is defined based upon fuel distribution patterns.

The system 10 includes several different components or subsystems, including a fluid-based distribution system shown generally at 12 and comprising the pipes and nozzle systems through which the fire retardant is delivered to and applied on surfaces, a carrier (such as water or other fire retardant carrier) and fire retardant storage system shown generally at 14 and comprising the storage tanks for storing separately both the carrier and the fire retardant when the system is not in use, and pressurization tanks for pressurizing the system and associated hardware, and a control system shown generally at 16 and comprising generally the devices necessary for activating the distribution system 10. Each of these components is described in detail below.

The system 10 shown in the figures illustrates a typical residential installation in which the system is configured to deliver the water based fire retardant to the exterior surfaces of the building 24, a deck 26 attached to the building, and surrounding areas such as landscaping 28. In FIG. 1, the building is shown located adjacent to a canyon area 30 to illustrate both structure protection and possible “flanking” distribution.

The distribution system 12 is shown in isolation in FIG. 2 and comprises a system of pipes 20 and distribution spray nozzles connected to the pipes at engineered positions. The distribution system 12 illustrated herein also includes pipes 20 extending to the edge of the canyon area 30. The type and size of piping 20 used in a distribution system 12 depends on factors such as the size of the system and the amount of water and retardant that will be delivered through the system. Generally, any type of UV resistant tubing will work well for the pipes 20 used in system 12, including for example polyvinylchloride (PVC) pipe, polyethylene tubing, copper tubing, galvanized pipe, or steel pipe, to name just a few non-limiting examples. With some combinations of metallic pipe and fire retardant, care must be taken to avoid corrosion of the pipes caused by the particular retardant that is used. The diameter of the pipe 20 also depends on the volume and the operating pressure of fire retardant delivered through the system.

The pipes 20 and associated distribution spray nozzles define a distribution system 12 for the fire retardant contained in the storage system 14. The piping is connected to the various source tanks for the fire retardant as described below and is plumbed through the walls of the structure or is buried underground. In some embodiments, the piping 20 is installed during initial construction of the building 24 so that it may be installed in an “in-wall” manner for aesthetic purposes, under sheet rock and the like. However, the system 10 may often be retrofitted into existing buildings, in which cases the piping 20 may be run under eves and the like in a manner designed to be as inconspicuous as possible, while maintaining convenient access for maintenance purposes.

The distribution system 12 may include several different types of distribution spray nozzles. Each nozzle has a specified purpose. For example, exterior wall nozzles 34 are located at strategic positions along the perimeter of the building 24 so that the exterior surfaces of the building 24 are coated with fire retardant when the system is activated. Thus wall nozzles 34 are mounted under the eves or overhangs of building 24 and are configured to direct a sprayed stream of fire retardant onto the exterior walls of the building. There are six wall nozzles 34 shown in FIGS. 1 and 2, but as many wall nozzles are plumbed into the system as are necessary to uniformly coat the entire exterior wall surface area (or as much thereof as is practical). In some embodiments, wall nozzles 34 may be mounted approximately every 30 lineal feet along the length of the wall, but the separation may be more or less depending upon system design specifics.

Likewise, the system 10 shown in FIGS. 1 and 2 includes two deck nozzles 36 located around deck 26. These deck nozzles direct a spray of fire retardant onto the horizontal surface of the deck and if desired, may be the type of nozzles that rotate through a complete circle so that they also deliver fire retardant to adjacent landscape areas.

In FIGS. 1 and 2 there are four roof nozzles 38 situated so that they spray the entire roof surface. And the system 10 shown in FIG. 2 includes nine separate landscape nozzles 40 positioned around the landscaping 28, two of which (labeled 40a, 40b) are positioned adjacent to the canyon area 30. It will be appreciated that in some embodiments the pipe 20 is buried underground in the landscaped areas for many reasons, including aesthetic, climate protection and damage control.

Each of the nozzles used with system 10 is of a type appropriate for the specific location. In some embodiments, wall nozzles 34 typically are misting or flat sheet spray nozzles having about ½ inch diameter. These nozzles are mounted in some embodiments under the eaves of the building such that the nozzles protrude about 1 and ½ inches from the eave. These nozzles may be plastic, stainless steel, or brass, to name just a few non-limiting examples. In some embodiments, these nozzles do not rotate but instead direct a spray, stream, arc or mist directly onto the vertical walls of the building. Nonetheless, in other embodiments these nozzles may be configured to rotate when they are pressurized to thereby spray fire retardant onto adjacent surfaces such as soffits, decks and the surrounding exterior ground.

In some embodiments, the deck nozzles 36 may be of the type typically seen in in-ground irrigation systems, such as pressure pop-up rotating sprinkler nozzles. These nozzles may be set to rotate through a complete 360° circle, or only part of a circle. In other embodiments, impact driven sprinkler nozzles may also be used for the deck nozzles.

Roof nozzles 38 may be of the spray or impact type. In many embodiments, all nozzles in system 10 are mounted so that they are either concealed or minimally visible when not in use so as not to detract from the aesthetic appearance of building 24. Thus, retractable type distribution nozzles may be mounted in the ground or in special boxes mounted on the deck, for example. Similarly, the roof nozzles 38 may be mounted in architectural features on the peak of the roof such as cupolas or dormers. The cupola may be built to include blowout louvers and similar fittings that are instantly blown out when the fire retardant begins spraying out of a nozzle. A cupola also may be built to accommodate a retractable sprinkler head for use in the roof nozzle 38. Regardless of the type of nozzle used, there are sufficient roof nozzles 38 located along the peaks and ridges of the building's roof so that the entire roof is sufficiently and uniformly coated with fire retardant as to prevent and protect substantially the potential wildfire damage.

Similarly, the landscape nozzles 40 are selected to be of a type that is appropriate to the particular location. Pressure operating, retractable distribution nozzles are used in some embodiments, but other distribution heads also work well. With respect to the two landscape nozzles 40a and 40b located adjacent to the edge of the canyon area 30, these are in some embodiments impact heads, or “gun” type agricultural heads more commonly used to irrigate row crops.

In many embodiments, the distribution system 12 is not charged with fire retardant when the system is not in use. In other words, the pipe 20 is empty when the system is not in use. This eliminates any problems with freezing or corrosion from the fire retardant resident in the pipes (in combinations where this is a concern).

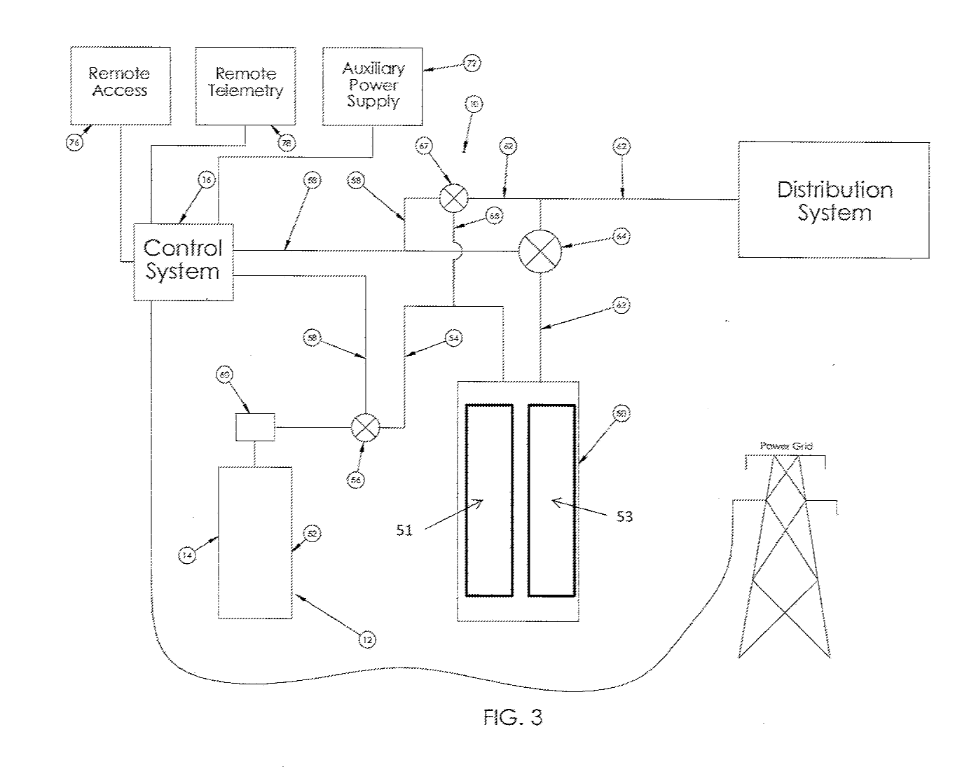

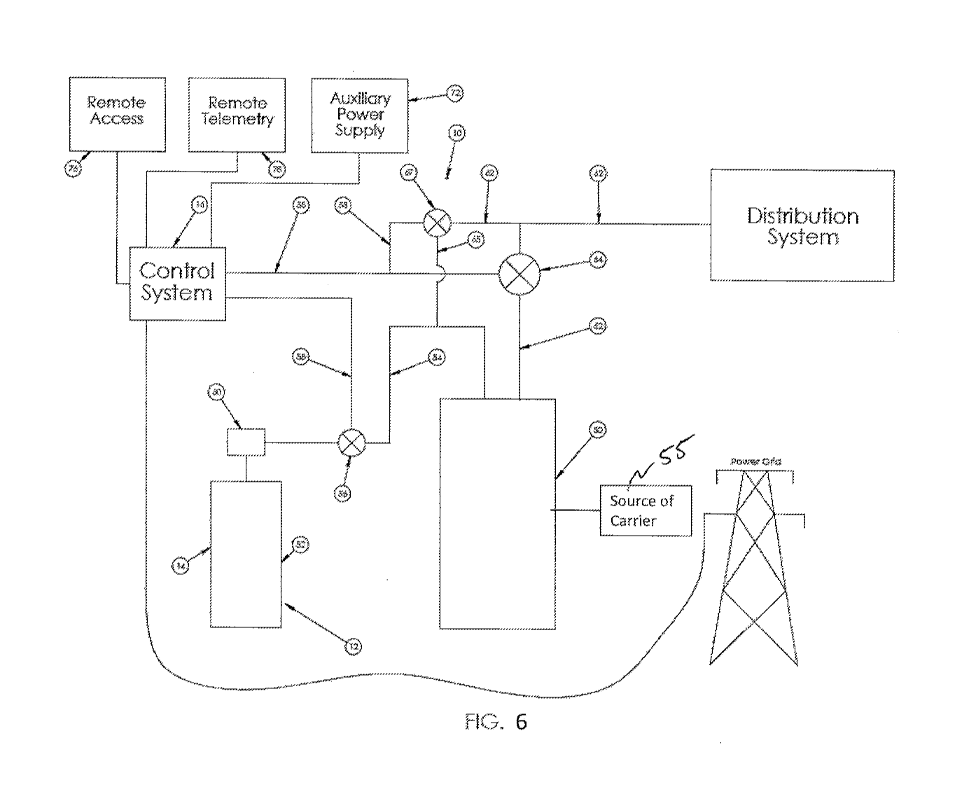

The storage system 14 will now be described in detail with particular reference to FIG. 3. In FIG. 3, the distribution system 12, storage system 14 and control system 16 are shown schematically. Storage system 14 comprises one or more water or other carrier based fire retardant tanks, pressurization systems, and control valves for operating the system. Specifically, the storage system 14 illustrated in FIG. 3 typically utilizes a double tank arrangement 50 and a single pressurization tank 52. In some instances the double tank arrangement will be modified to include either a single tank or some multiple of the double tank arrangement. Alternatively, in some instances, as shown in FIG. 6, the system relies on a carrier from a source other than a tank such as a water well, municipal water supply, pond, water well, water tank, lake, or any other such water supply source that is used to provide a carrier that is fluidly coupled with a fire retardant from a tank. Hereinafter said tank arrangements will be referred to as “double tank arrangement 50”. The double tank arrangement 50 contains both water or other carrier and the fire retardant, separated for storage purposes into a carrier tank 51 and a retardant tank 53. During storage, the carrier and the fire retardant are stored in a non-pressurized state. The size and volume of said tanks 50 varies according to the size of system 10. The double tanks 50 are sized so that the tanks have adequate volume to spray the desired volume of the fire retardant mixture uniformly over the entire area intended to be covered by the system 10. A variety of tank types may be used for the double tank arrangement 50. For example, double tank arrangement 50 may be fiberglass reinforced plastic, HDPE or steel, lined appropriately with corrosion resistant materials, to thereby prevent corrosion in the tanks which may impair system function when needed for fire suppression purposes. In a typical residential installation, the double tank arrangement 50 has a combined capacity of about 100 to about 350 gallons or larger. Larger tanks of up to 10,000 gallons or more may be used with large structures or where retardant is to be sprayed over a large area or in community-based systems.

Some kinds of fire retardants that may be used in system 10 tend to stratify or chemically separate over time, rendering them inactive or ineffective. Depending upon the type of fire retardant used, the double tank arrangement 50 may be fitted with agitators such as bubbler or paddle-type mixers to keep the fire retardant homogenous and active or useful over time. A secondary bubbling line (not shown) may be run from the pressure tank 52 into the fire retardant tank 50 to cause either continuous or intermittent bubbling of nitrogen or other gas, which is sufficiently chemically inert to be useful and practical, through the fire retardant to mix the fire retardant and thus prevent stratification. The control system 16 may be configured to provide bubbling into the fire retardant tank itself when the system 10 is either activated or when stratification is suspected or to prevent stratification by time cycle operation.

The double tank arrangement 50 is plumbed to pressure tank 52 through a pressure line 54. A valve 56 is in pressure line 54 and is, as detailed below, connected to and operable under the control of control system 16 through control line 58. A pressure regulator 60 with a vent is provided to regulate the pressure in pressure tank 52. A system flush pipe 65 branches from pressure line 54 and connects to outlet pipe 62 upstream from valve 64. A valve 67 is plumbed into flush pipe 65. The system flush pipe 65 is explained below.

In some embodiments, pressure tank 52 may be a commercially available cylinder or set of cylinders charged with an inert pressurized gas such as nitrogen that serves as the motive force for the system 10 to deliver the water based fire retardant through pipes 20 to the various nozzles. Pressure tank 52 is of a sufficient volume and is charged to an appropriate pressure such that when the system 10 is activated, all or a portion of the fire retardant mixture contained in the double tank arrangement 50 may be delivered through the nozzles at an operating pressure appropriate to the system—about 50-60 psi in some embodiments. A pressure regulator is typically used to regulate the operating pressure of gas delivered from pressure tank 52 to the double tank arrangement 50 and the nozzles downstream of the tank 50. In some embodiments, the double tank arrangement 50 is capable of being pressurized up to about 120 psi or less.

Upon actuation of the system 10 the fire retardant and the carrier are mixed into a fire retardant and carrier mixture. Fire retardant contained in the double tank arrangement 50 is delivered to the piping 20 on FIG. 2 of distribution system 12 through an outlet pipe 62. As noted, a valve 64, which is under the control of the control system 16 through control line 58, is plumbed into outlet pipe 62 near the double tank arrangement 50.

In one embodiment, as shown in FIG. 6, the double tank arrangement 50 in FIG. 3 may be limited to a single or multiple tank arrangement of fire retardant in which case the carrier is not contained within a tank. In such a non-limiting example, the carrier is provided through another source 55 such as a water well, municipal water supply, pond, water well, water tank, lake or any other carrier source available piped to the fire retardant tank or tanks through a piping system. In such a non-limiting example, the other carrier source is fluidly coupled to the single or multiple tanks of fire retardant and delivered to the piping on FIG. 2 of distribution system 12 through an outlet pipe 62.

In installations of system 10, the storage system 14 on FIG. 2 may be located in any appropriate setting such as in a garage, HVAC area, out building or constructed pad.

It will be appreciated that storage system 14 may utilize multiple double tank arrangements 50 and multiple pressure tanks 52 if the size of the system 10 is sufficient to warrant the capacity achieved by additional tanks.

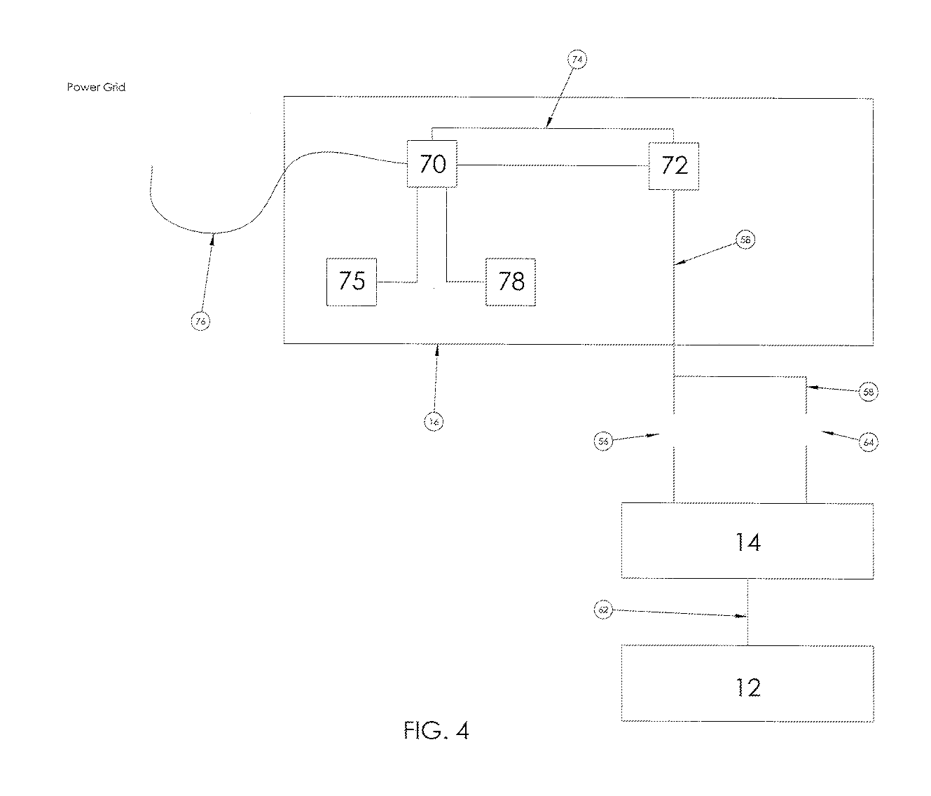

Control system 16 (or activation system 16) is shown schematically in detail in FIG. 4 and includes an activation switch 70, which is typically an electronic switch such as a solenoid or mechanical relay or the like, and an auxiliary power supply 72 such as an external battery and/or uninterruptible power supply module. The control system 16 is operably coupled to the motive source and operable to actuate the motive source. Activation switch 70 is the main on/off switch for activating system 10 and is normally powered by the power supply to the building or location. However, in wildfire situations electric power from public utilities and the like may be cut off. Auxiliary power supply 72 provides electric power to activation switch 70 through wiring 74 to ensure that activation switch 70 is powered under all circumstances, even where the external electrical power supply has been interrupted. As indicated earlier, control lines 58 interconnect control system 16 to valves 56 and 64, which preferably are electrically operated solenoid valves. Alternately, all of the valves described herein may be operated pneumatically, hydraulically or manually (to name just a few non-limiting examples), depending on the type of system that is being used.

Activation switch 70 is operable under a variety of input systems that are capable of activating system 10. For example, switch 70 may be activated with a manual switch 75 that is located in, on or adjacent to the building 24. If a wildfire is approaching the building, the manual switch 75 is activated to begin activation of the system 10.

Activation switch 70 is further operable via coded remote activation 76 such as an internet portal access, mobile device application or as a coded series of tones (such as DTMF tones generated by a telephone handset) as may be desired. Thus, control system 16 may include a telephony systems wire to the landline, cellular or satellite phone systems so that switch 70 may be remotely operated by calling a specific telephone number and entering codes manually or automatically. The building owner, the local fire departments, etc. may use the coded remote access 76 by dialing the number, activating the applications or suitably transmitting a code or signal. Switch 70 may also be operated by on-site detectors 78 such as infrared, smoke, temperature, and/or other fire detectors located around the building, or by similarly situated RF or IR or laser controlled devices. For example, an infrared detector may be located near the edge of canyon area 30. If a wildfire is detected, the detector is capable of activating switch 70. Similarly, heat sensors and other types of similar sensors may be located around or near a building, or near the edge of canyon area 30 and configured for activating system 10.

The fire retardant used in system 10 is in some embodiments a liquid, gel or powder that when properly combined or mixed with water or other carrier flows readily through the plumbing systems and through the nozzles. Because the retardant component may not be used for several years after double tank arrangement 50 is filled, in some embodiments the retardant is not prone to degradation in effectiveness over time. Because the fire retardant is sprayed over buildings, in some embodiments the retardant does not discolor building surfaces, does not harm vegetation, and causes no other environmental damage. A wide variety of fire retardants suitable for use in system 10 are commercially available and may be selected on a project-by-project basis. By way of non-limiting example, fire retardants marketed commercially under the brand names Barricade, Phos-Chek, TetraKO, and FireIce may be used.

Operation of system 10 will now be detailed. When system 10 is not in use, or “idle”, the fire retardant double tank arrangement 50 is substantially filled with water or other suitable carrier and the fire retardant respectively but is not pressurized; alternatively, a single tank or multiple tanks may be filled with fire retardant and a suitable carrier is provided through any other suitable source of carrier (not within the tank(s)). Valves 56, 64 and 67 are closed. System 10 is activated in any number of the ways detailed above. For purposes of illustration, in this case it is assumed that the system 10 is installed in a residential structure and authorities, because of the threat posed by an approaching wildfire, have evacuated the resident of the structure. In other words, the system 10 was not activated prior to the building being evacuated. When the owner deems that the structure is imminently threatened by wildfire, the owner accesses the system by the Internet, smart phone application or calls the number for the coded remote activation 76 of control system 16 on either a WiFi portal, landline, cellular or satellite phone. The coded remote activation 76 is configured to respond to the incoming access signal and will prompt the caller to activate switch 70—that is, to turn switch 70 from the “off” to the “on” position. For example, the coded remote activation 76 may prompt the caller to enter an authorization code such as a user name and password or numeric code to first insure that the caller is authorized to give the system further instructions. If the correct user name and password or numeric code is entered, the coded remote activation 76 will next prompt the caller to a specific activation code or selection from a menu that may include status checks, inputs from sensors or to activate the activate switch 70.

When the caller enters the activation code, control system 16 sends appropriate signals to valves 56 and 64, which as noted are electrically operated valves such as solenoid valves, causing the valves to open. As valve 56 opens, gas from the pressure tank 52 flows into and pressurizes the double tank arrangement 50. With valve 64 open, both the water and fire retardant begins flowing into outlet pipe 62 under the pressurizing force applied by gas from pressure tank 52, and thus into the entire distribution system 12. Proportional measures of both carrier and the fire retardant are maintained by pre-set pressures or other such mixing systems such as injector, venturi eduction, injection pitot etc. The mixing system may contain multiple points of injection, venturi eduction, injection pitot, etc. The now blended or mixed fire retardant flows quickly into pipes 20 and begins to be discharged from each of the nozzles in the system. Although the nozzles in the system are configured to apply the desired amount of fire retardant onto adjacent surfaces, a typical application rate is between the range of 0.5 and 5 gallons per 100 square feet of surface. The desired amount may be calculated by the control system at the time of activation with inputs from remote sensors or the owner/operator. Additionally, this application rate may vary with the type of fire retardant used.

The fire retardant is sprayed out of the nozzles onto the intended surfaces until either the entire volume contained in the double tank arrangement 50 is sprayed through the nozzles, or the system is deactivated by deactivating switch 70—that is, the switch 70 is moved from the “on” to the “off” position which is dependent on the type of switch selected by the design process. In this regard, in some embodiments pressure tank 52 contains enough pressurized gas to discharge the entire contents of fire retardant contained in the double tank arrangement 50 when said double tank arrangement 50 is full, and to clear all fire retardant contained in all plumbing lines in distribution system 12. Thus, if the system 10 remains activated until all fire retardant is discharged through the nozzles, gas from pressure tank 52 will flush all plumbing lines of fire retardant.

Similarly, the activation switch 70 may be turned off in any of the ways described above at any time after activation. When the control system 16 deactivates the system 10 (i.e. turns switch 70 off), both valves 56 and 64 are closed. The activation switch may be turned off and then turned on again at a later time provided there is sufficient water and fire retardant in the double tank arrangement 50.

Control system 16 is capable of closing valves 56 and 64 at different times. For example, valve 56 may be closed before valve 64 so that the double tank arrangement 50 is allowed to depressurize for an interval of time. Valve 64 is then closed by control system 16. If deactivation is accomplished through use of various types of coded remote activation 76 (as previously described) before all water or fire retardant contained in double tank arrangement 50 has been discharged through system 10, the fire retardant mixture remaining the in the pipes 20 downstream of double tank arrangement 50 may be flushed out to clear the piping in the system to ready it for the next use. This is done by opening valves 56 and 67 with valve 64 closed. Valves 56 and 67 are allowed to remain open until all residual fire retardant has been discharged through the various nozzles.

In some embodiments, the fire retardant used in the system 10 is of the type that will remain on the surface onto which it has been sprayed, providing continuing protection against wildfire, until the residual retardant has been washed off. It will be appreciated by those of ordinary skill in the art that certain modifications and additions may be made to the system 10 as described above and shown in the drawings. For example, the system may be designed to operate on a manual basis only, thereby omitting control system 16. In this case, only one manually operable valve may be used in place of valve 56 shown in the drawings and the system is activated by manually opening the valve to deliver gas from the pressure tank to the double tank arrangement 50. Also a hose having a nozzle on one end may be connected to the double tank arrangement 50 to allow mixed fire retardant to be manually sprayed on specific locations. Separate lines may be plumbed into the system similar to standard hose bibs that allow firefighters to connect external hoses to the actual fire retardant supply. As yet another modification, large “guns” of sprinkler heads such as impact heads may be mounted at tree-top level to provide greater coverage of the surrounding structures. Moreover, entire communities may be protected by a single, large-scale installation along the lines noted above. In this case, each structure in a community may be individually protected by a system 10, with a community perimeter system for delivering fire retardant to a line around the community may be used to great effect.

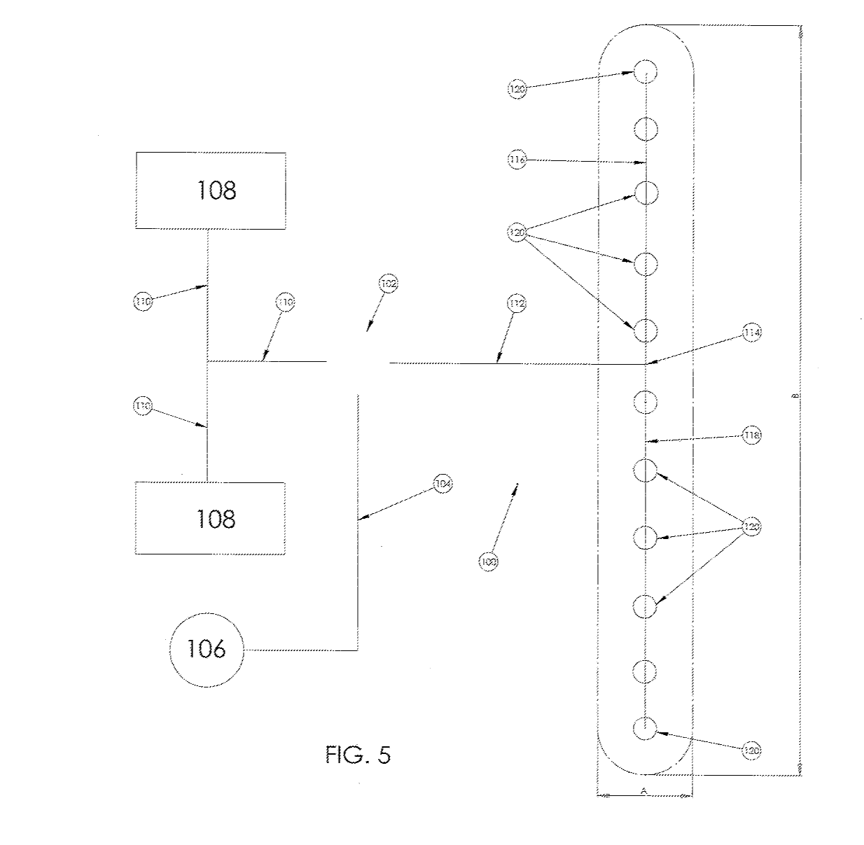

An additional embodiment is shown in FIG. 5. In this system 100, which is the type of system that is used to flank a fire to control fire direction or stop the fire's progress in a specific direction, a series of “big gun” distribution heads (such as those available from Nelson Irrigation Corporation, 848 Airport Road, Walla Walla, Wash. 99362-2271 USA) are positioned to spray fire retardant in a line over a relatively long distance. In many areas, historical fire data is available that provides a reliable statistical indicator of the direction that wildfires travel. In other words, in any given area, by relying upon factors such as weather, wind patterns, fuel distribution and historical fire data, firefighters are able to reliably predict wildfire direction and behavior. The system 100 is used to flank a fire by laying down a long line of fire retardant that is intended to stop a fire, or channel it away from a residential area, or toward an area where it is easier to fight, etc.

In some embodiments, system 100 relies upon a compressed gas powered pump 102 that is powered by compressed gas delivered to pump 102 through a line 104 that interconnects the pump to a tank 106 of a suitable compressed gas. Pump 102 may be a diaphragm-type pump such as the IR ARO™ diaphragm-type pumps available from Ingersoll-Rand Fluid Products (170/175 Lakeview Drive, Airside Business Park, Swords, Co. Dublin, Ireland), to name just one non-limiting example, and may be powered with compressed nitrogen or air in tank 106.

One or more reservoirs 108 consisting of multiple double tank arrangements 50 of both carrier or fire retardant are plumbed to pump 102 through pipes 110. These reservoirs 108 may be portable or located above ground, underground, or remotely from pump 102, as may the tank 106, depending upon the specific installation. A single outflow pipe 112 from pump 102 may be connected to a T-fitting 114 and there are two branch lines 116, 118 extending from the T-fitting. Plural spray distribution heads 120 are plumbed inline in the branch lines 116 and 118-twelve distribution heads 120 are shown in the system 100 in FIG. 5.

Each distribution head 120 is preferably a “big gun” type of spray head configured to distribute a desired quantity of fire retardant. In the embodiment illustrated in FIG. 5, the system 100 is pressurized and the components are sized so that fire retardant is sprayed from each distribution head in a circle having a diameter of about 100 feet (dimension A in FIG. 5). It will be appreciated that the length of the perimeter line defined by branch lines 116 and 118 may be up to ¼ mile, and more, as shown by dimension B, FIG. 5. The area of ground onto which fire retardant is distributed with the system 100 is illustrated with dashed lines around the perimeter of the system.

Depending upon the area that is to be protected, several systems 100 may be arranged in series to provide a protection line that is many miles in length. The system 100 may beneficially be used to deliver fire retardant to at least a part of a perimeter around a residential area, and in particular those perimeter areas that are most prone to be hit by wildfire.

System 100 includes activation means for activating the system, which may be of any of the types described above.

While the present embodiments have been described in terms of several illustrated embodiments, it will be appreciated by one of ordinary skill that the spirit and scope of the embodiments is not limited to those embodiments, but extend to the various modifications and equivalents as defined in the appended claims.

What is claimed is:

1. A fire retardant delivery system for protection from wildfire, comprising:
a retardant tank for storing a fire retardant;
a source of carrier for the fire retardant,
a motive source in communication with the retardant tank and the source of carrier;
an activation system operably coupled to the motive source and operable to actuate the motive source so that the fire retardant and the carrier are mixed into a fire retardant and carrier mixture after actuation of the motive source;
at least one distribution nozzle configured to deliver the fire retardant and carrier mixture to a desired area.

2. The fire retardant delivery system of claim 1 further comprising a sensor operably coupled to the activation system and configured to actuate the activation system when the sensor detects a fire near the desired area.

3. The fire retardant delivery system of claim 2, wherein the sensor is a heat sensor.

4. The fire retardant delivery system of claim 1, wherein the motive source comprises at least one of a pump, an inert gas, a compressed gas, air, gravity, a combustible fuel, or a power source.

5. The fire retardant delivery system of claim 1, wherein the fire retardant and the carrier are stored in a non-pressurized state.

6. The fire retardant delivery system of claim 5, wherein the supply of a motive source pressurizes the fire retardant and carrier to discharge the fire retardant and carrier mixture from the at least one distribution nozzle.

7. The fire retardant delivery system of claim 1, wherein the retardant tank and the source of carrier are located underground.

8. The fire retardant delivery system of claim 1, wherein the activation system is configured to be remotely actuated.

9. The fire retardant delivery system of claim 1, wherein:
the desired area defines at least a partial perimeter around a structure; and
the at least one distribution nozzle is arranged to deliver the fire retardant and carrier mixture to the desired area to flank a fire and prevent the fire from reaching the structure.

10. The fire retardant delivery system of claim 1, wherein the fire retardant is at least one of a liquid, a gel, or a powder fire retardant.

11. The fire retardant delivery system of claim 1, wherein the source of carrier is a carrier tank.

12. The fire retardant delivery system of claim 1, wherein the source of carrier is selected from the group consisting of: a water tank, a municipal water supply, a water well, lake and a pond.

13. A method of delivering fire retardant over a desired area, the method comprising:
storing a fire retardant in a retardant tank;
supplying a source of carrier for the fire retardant;
operatively coupling a motive source to the retardant tank and the source of carrier;
actuating the motive source with an activation system so that the fire retardant and the carrier are mixed into a fire retardant and carrier mixture after actuation of the motive source; and
delivering the fire retardant and carrier mixture to the desired area through at least one distribution nozzle.

14. The method of claim 13 further comprising actuating the motive source when a sensor detects a fire near the desired area.

15. The method of claim 14 further comprising detecting heat with the sensor.

16. The method of claim 13, wherein coupling a motive source with the retardant tank and the source of carrier further comprises fluidly coupling a supply of pressurizing force with the retardant tank and the source of carrier.

17. The method of claim 13 further comprising storing the fire retardant and the carrier in a non-pressurized state.

18. The method of claim 17 further comprising pressurizing the fire retardant and carrier with the motive source to discharge the fire retardant and carrier mixture from the at least one distribution nozzle.

19. The method of claim 13 further comprising locating the retardant tank and the source of carrier underground.

20. The method of claim 13 further comprising remotely actuating the motive source.

21. The method of claim 20 further comprising remotely actuating the motive source through remote telemetry and access methods.

22. The method of claim 21, wherein the desired area defines at least a partial perimeter around a structure, the method further comprising arranging the at least one distribution nozzle to deliver the fire retardant and carrier mixture to the desired area to flank a fire and prevent the fire from reaching the structure.

23. The method of claim 13, wherein storing a fire retardant in a retardant tank further comprises storing at least one of a liquid, a gel, or a powder fire retardant in the retardant tank.

24. The method of claim 13, wherein actuating the motive source comprises actuating at least one of a pump, an inert gas, a compressed gas, air, gravity, a combustible fuel, or a power source.

25. The method of claim 13 further comprising storing the carrier in a carrier tank.

26. The method according to claim 13 further comprising defining the desired area as an area between a structure and at least one historical fire originating location.

27. The method according to claim 13 further comprising defining the desired area based upon temperature inputs from real-time remote telemetry.

28. The method according to claim 13 further comprising defining the desired area based upon relative humidity inputs from real-time remote telemetry.

29. The method according to claim 13 further comprising defining the desired area based upon wind patterns inputs from real-time remote telemetry.

30. The method according to claim 13 further comprising defining the desired area based upon historical fire data.

31. The method according to claim 13 further comprising defining the desired area based upon fuel distribution patterns.

32. The fire retardant delivery system of claim 13, wherein the source of carrier is selected from the group consisting of: a water tank, a municipal water supply, a water well, lake and a pond.
